(19) United States
(12) Patent Application Publication
(10) Pub. No.: US 2025/0079461 A1
(43) Pub. Date: Mar. 6, 2025

(54) ANODE ACTIVE MATERIAL AND ITS MANUFACTURING METHOD, LITHIUM ION BATTERY AND ALL-SOLID-STATE LITHIUM THIN-FILM BATTERY USING THE SAME

(71) Applicant: KOREA INSTITUTE OF SCIENCE AND TECHNOLOGY, Seoul (KR)

(72) Inventors: Ji-Won CHOI, Seoul (KR); Haena YIM, Seoul (KR); Yaelim HWANG, Seoul (KR); Chong Yun KANG, Seoul (KR); Seung Hyub BAEK, Seoul (KR); Seong Keun KIM, Seoul (KR); Hyun-Cheol SONG, Seoul (KR); Jungho YOON, Seoul (KR); Ji-Soo JANG, Seoul (KR); Sunghoon HUR, Seoul (KR)

(21) Appl. No.: 18/816,387

(22) Filed: Aug. 27, 2024

(30) Foreign Application Priority Data
Aug. 29, 2023 (KR) 10-2023-0113918

(51) Int. Cl. H01M 4/58; C01B 21/082; H01M 4/02; H01M 10/0525

(52) U.S. Cl. CPC H01M 4/58; C01B 21/0823; H01M 10/0525; C01P 2002/84; C01P 2004/03; C01P 2006/40; H01M 2004/027

(57) ABSTRACT

The present invention relates to a transparent anode active material having excellent light transmittance and electrical conductivity characteristics and a manufacturing method thereof, and a lithium ion battery and an all-solid-state lithium thin-film battery based on the same and having excellent charge/discharge capacity and charge/discharge rate, wherein the transparent anode active material according to the present invention is characterized by comprising a material of the following Chemical Formula 1: AgₓSiO_{y}N wherein x is 0<x≤0.8 and y is 0<y≤1.

### CROSS REFERENCE TO RELATED APPLICATION

The present application claims priority to Korean Patent Application No. 10-2023-0113918, filed on Aug. 29, 2023, the entire contents of which is incorporated herein for all purposes by this reference.

### Description about National Research and Development Support

This study was supported by the technology development programs of Ministry of Science and ICT, Republic of Korea (Projects No. 1711198493 and No. 1711184064) under the Korea Institute of Science and Technology.

### BACKGROUND OF THE INVENTION

### Field of the Invention

The present invention relates to an anode active material and a manufacturing method thereof, and a lithium ion battery and an all-solid-state lithium thin-film battery using the same, and more specifically, to an anode active material having excellent light transmittance and electrical conductivity characteristics and a manufacturing method thereof, and a lithium ion battery and an all-solid-state lithium thin-film battery based on the same and having excellent charge/discharge capacity and charge/discharge rate.

### Description of the Related Art

The development of transparent energy sources is required due to the rapid development of transparent devices such as smart lenses, augmented reality (AR) displays, smart windows, and biosensors. However, in order to implement a transparent battery, all components of the battery, such as a positive electrode, an anode, an electrolyte, and a current collector, must be transparent and have excellent electrochemical properties, and thus, there have been limitations in the development of transparent batteries.

LiFePO₄, LiMnPO₄, etc., which are widely used as positive electrode active materials, have a wide energy band gap of 3.8 to 4.0 eV, making it easy to obtain transparent characteristics, and LiPON, which is most widely used as a solid electrolyte, exhibits transparent characteristics by itself. On the other hand, in the case of negative electrode active materials and negative electrode current collectors, the development of materials with transparent properties is lacking.

In order to manufacture a transparent negative electrode, a technology for manufacturing a grid-type negative electrode through a photoetching process of an opaque conductive material has been proposed (see Non-Patent Documents 1 and 2), but the grid-type negative electrode has no choice but to have a limited area, and thus has a problem of low energy density.

The present applicant and inventors have proposed a transparent negative electrode active material composed of SiNₓ (0<x≤1.5) through Korean Patent Registration No. 2436632 (Patent Document 1). The SiNₓ transparent negative electrode active material presented in Patent Document 1 realized a high light transmittance of 89%, a long lifespan compared to Si negative electrode active materials, and a high discharge capacity compared to carbon materials. However, despite such high light transmittance and lifespan characteristics, the SiNₓ transparent negative electrode active material presented in Patent Document 1 has the disadvantage of having low electrical conductivity compared to the existing opaque conductive materials.

### Documents of Related Art

### Patent Documents

(Patent Document 1) U.S. Pat. No. 9,184,444 (registered on Nov. 10, 2015)

(Patent Document 2) Korean Patent Laid-Open Publication No. 2022-0070044 (published on May 27, 2022)

### Non-patent Document

(Non-patent Document 1) Yang Y et al., Transparent lithium-ion batteries. Proc Natl Acad Sci USA 2011;108 (32): 13013-8.

(Non-patent Document 2) Oukassi S et al., Transparent thin film solid-state lithium ion batteries. ACS Appl Mater Interfaces 2019;11 (1): 683-90.

### SUMMARY OF THE INVENTION

### Technical Problem

The present invention has been devised to solve the above problems and aims to provide an anode active material having excellent light transmittance and electrical conductivity characteristics and a manufacturing method thereof, and a lithium ion battery and an all-solid-state lithium thin-film battery based on the same and having excellent charge/discharge capacity and charge/discharge rate.

### Technical Solution

The negative electrode active material according to the present invention for achieving the above object is characterized by comprising a material of Chemical Formula 1 below:

AgₓSiO_{y}N [Chemical Formula 1]

wherein x is 0<x≤0.8 and y is 0<y≤1.

The Ag molar ratio (x) may be limited to 0.030≤x≤0.236, and the negative electrode active material has a light transmittance of 60% or more for light with a wavelength of 550 nm. In addition, the negative electrode active material with the Ag molar ratio (x) of 0.030≤x≤0.236 has a maximum electrical conductivity of 67.5 kS/cm.

The Ag molar ratio (x) may be limited to 0.030≤x≤0.765.

The method for manufacturing an anode active material according to the present invention is characterized by manufacturing an anode active material comprising a material of the following Chemical Formula 1 through a room temperature deposition process:

AgₓSiO_{y}N [Chemical Formula 1]

wherein x is 0<x<0.8 and y is 0<y≤1.

The Ag molar ratio (x) may be limited to 0.030≤x≤0.765.

The room temperature deposition process may be a sputtering process.

In the sputtering process, a Si target and an Ag target may be used, and a mixed gas of nitrogen (N₂) and argon (Ar) may be supplied at a N₂/Ar ratio of 1 to 3% under a vacuum atmosphere.

The room temperature deposition process may use any one of pulsed laser deposition (PLD) and plasma chemical vapor deposition (PECVD).

The all-solid-state lithium thin-film battery according to the present invention has a structure in which an anode current collector, an anode active material, a solid electrolyte, and a positive electrode active material are sequentially stacked on a substrate, wherein the negative electrode active material is characterized by comprising a material of Chemical Formula 1 below:

AgₓSiO_{y}N [Chemical Formula 1]

wherein x is 0<x≤0.8 and y is 0<y≤1.

The Ag molar ratio (x) may be limited to 0.030≤x≤0.765.

The negative electrode active material may have an Ag molar ratio (x) of 0.030≤x≤0.236, and a light transmittance of 60% or more. The all-solid-state lithium thin-film battery to which an anode active material having an Ag molar ratio (x) of 0.030≤x≤0.236 is applied may have a maximum discharge capacity of 242.8 μAh/cm²·μm. In addition, the all-solid-state lithium thin-film battery to which an anode active material having an Ag molar ratio (x) of 0.030≤x<0.236 is applied may have a discharge capacity of 92.8 μAh/cm²·μm or more at a charge/discharge rate of 10 C.

The negative electrode current collector, solid electrolyte, and positive electrode active material may comprise transparent materials.

The lithium ion battery according to the present invention is characterized by employing a material of the following Chemical Formula 1 as an anode active material:

AgₓSiO_{y}N [Chemical Formula 1]

wherein x is 0<x≤0.8 and y is 0<y≤1.

The Ag molar ratio (x) may be limited to 0.030≤x≤0.765.

The lithium ion battery may have a maximum discharge capacity of 219.4 μAh/cm²·μm.

### Advantageous Effects

The negative electrode active material and its manufacturing method according to the present invention, and the lithium ion battery and all-solid-state lithium thin-film battery using the same have the following effects.

The negative electrode active material comprising AgₓSiO_{y}N (x is 0<x≤0.8 and y is 0<y≤1) may be selectively used for transparent or opaque purposes depending on the Ag molar ratio (x). When the Ag molar ratio (x) is 0.030≤x<0.236, it has a light transmittance of 60% or more and an electrical conductivity exceeding 100 times that of SiO_{0.7}N. Additionally, when the Ag molar ratio (x) is 0.236<x≤0.765, the light transmittance is less than 60%, but the electrical characteristics are better.

Based on these characteristics, the all-solid-state lithium thin-film battery using AgₓSiO_{y}N as an anode active material has a discharge capacity of 6 times or more as compared to the all-solid-state lithium thin-film battery using SiO_{y}N as an anode active material, and also exhibits a discharge capacity characteristic of 92.8 μAh/cm²·μm or more at a charge/discharge rate of 10 C.

### BRIEF DESCRIPTION OF THE DRAWINGS

FIG. 1 is an experimental result showing a thickness change according to the position of the AgₓSiO_{y}N thin film prepared in Experimental Example 1.

FIG. 2 is an SEM image of each of four points (x=0.030(P1), 0.053(P5), 0.110(P10), and 0.236(P15)) of the SiO_{y}N thin film produced in Experimental Example 1 and the AgₓSiO_{y}N thin film produced in Experimental Example 1.

FIG. 3 is the results of Rutherford backscattering spectroscopy analysis to confirm the composition of each of four points (x=0.030, 0.053, 0.110, and 0.236) of the SiO_{y}N thin film produced in Experimental Example 1 and the AgₓSiO_{y}N thin film produced in Experimental Example 1.

FIG. 4 is a photograph of each of 15 points (P1 to P15) of the SiO_{y}N thin film produced in Experimental Example 1 and the AgₓSiO_{y}N thin film produced in Experimental Example 1.

FIGS. 5 and 6 are the results of measuring a light transmittance at each point using a UV-vis spectrophotometer.

FIG. 7 is a result of measuring an electrical conductivity at each of 15 points (P1 to P15) of the SiO_{y} N thin film produced in Experimental Example 1 and the AgₓSiO_{y}N thin film produced in Experimental Example 1.

FIGS. 8 and 9 show the discharge characteristics during the first discharge and the charge characteristics during the first charge of 15 coin cells and the remaining 1 coin cell manufactured in Experimental Example 2 at a charge/discharge rate of 0.2 C, respectively.

FIG. 10 shows the discharge characteristics of 8 coin cells manufactured in Experimental Example 2 during the first discharge at a charge/discharge rate of 0.2 C.

FIG. 11 is a collection of data from FIGS. 8 and 10, and shows discharge capacities of 15 coin cells to which an AgₓSiO_{y}N thin film having an Ag molar ratio (x) of 0.030≤x≤0.236 is applied, 8 coin cells to which an AgₓSiO_{y}N thin film having an Ag molar ratio (x) of 0.261≤x≤0.765 is applied, and 1 coin cell to which an SiO_{y}N thin film is applied.

FIG. 12 shows the results of measuring discharge capacities after 100 charge/discharge cycles of 15 coin cells and the remaining 1 coin cell manufactured in Experimental Example 2.

FIG. 13 shows the results of measuring discharge capacities after 100 charge/discharge cycles of 8 coin cells manufactured in Experimental Example 2.

FIG. 14 shows the results of electrochemical impedance spectroscopy (EIS) performed on 15 coin cells and the remaining one coin cell prepared in Experimental Example 2.

FIG. 15 is a FE-SEM image of the cross section of an all-solid-state lithium thin-film battery (Li/LiPON/AgₓSiO_{y}N/Ni—Cr/Glass) prepared in Experimental Example 3.

FIG. 16 is an experimental result showing charge/discharge characteristics of an all-solid-state lithium thin-film battery (x=0.030, 0.053, 0.110, and 0.236) manufactured in Experimental Example 3 under a charge/discharge rate of 0.2 C.

FIG. 17 is a result of measuring discharge capacity after 100 charge/discharge cycles of an all-solid-state lithium thin-film battery manufactured in Experimental Example 3.

FIG. 18 is an experimental result showing the rate performance of an all-solid-state lithium thin-film battery manufactured in Experimental Example 3.

### DETAILED DESCRIPTION OF THE INVENTION

The present invention provides an anode active material having excellent light transmittance and electrical conductivity properties, and provides a technology capable of improving charge/discharge capacity and rate performance of a lithium ion battery and an all-solid-state lithium thin-film battery by applying the anode active material to each of the lithium ion battery and the all-solid-state lithium thin-film battery.

As previously described in the “Background Art”, the present applicant and inventors presented a transparent anode active material made of SiNₓ (0<x≤1.5) through Patent Document 1, wherein the SiNₓ transparent anode active material disclosed in Patent Document 1 has high light transmittance, long lifespan, and high discharge capacity compared to carbon materials, but has a limitation in terms of a relatively low electrical conductivity characteristic.

The present invention is a result of research conducted on the same line as Patent Document 1, and is to improve the transparent anode active material disclosed in Patent Document 1. That is, the present invention provides a novel material having improved electrical conductivity characteristics while maintaining high light transmittance characteristics of the SiNₓ transparent anode active material disclosed in Patent Document 1.

As the simplest method to solve the low electrical conductivity characteristics of the SiNₓ transparent anode active material disclosed in Patent Document 1, a method of adding conductive metal particles to the SiNₓ transparent anode active material may be considered, but there has been no attempt so far.

Accordingly, the present inventors have attempted a method of adding Ag to the SiNₓ anode active material, thereby solving the low electrical conductivity characteristics of the SiNₓ anode active material, and minimizing the decrease in light transmittance. In addition, high charge/discharge capacity and rate performance have been achieved by applying the Ag-doped SiNₓ anode active material as an anode active material of each of a lithium ion battery and an all-solid-state lithium thin-film battery.

Ag has been selected among various conductive metals because, in addition to high electrical conductivity, it has excellent electrical contact properties with Si and high affinity for lithium. In addition, it has been confirmed that Ag acts as a factor in improving the electrochemical properties and rate performance of lithium batteries by forming a solid electrolyte interface (SEI) in the anode active material.

The anode active material according to the present invention has a composition of Chemical Formula 1 below:

AgₓSiO_{y}N [Chemical Formula 1]

wherein x is 0<x≤0.8 and y is 0<y≤1.

The AgₓSiO_{y}N anode active material according to the present invention having the composition of Chemical Formula 1 has high light transmittance and excellent electrical conductivity characteristics. The AgₓSiO_{y}N anode active material has a form in which Ag nanoparticles are uniformly distributed in a SiON matrix, wherein the SiON matrix is a compound in which a trace amount of oxygen (O) is bonded to SiN_{z}.

In the AgₓSiO_{y}N anode active material, the Ag content, that is, the molar ratio of Ag, should be adjusted to have an optimal range.

As the content of Ag nanoparticles uniformly distributed in the SiON matrix increases, the electrical conductivity of AgₓSiO_{y}N increases, but the light transmittance and energy density of AgₓSiO_{y}N decrease. In other words, there is a trade-off between the electrical conductivity properties and light transmittance properties as the Ag content increases, and thus, the optimal range of Ag molar ratio (x) should be applied to satisfy the condition of minimizing the decrease in light transmittance while securing excellent electrical conductivity characteristics. In addition, if the Ag molar ratio (x) is too high, not only the light transmittance but also the energy density decreases.

The present inventors have manufactured AgₓSiO_{y}N having an Ag molar ratio (x) of 0.030≤x≤0.236, analyzed light transmittance and electrical conductivity characteristics for the AgₓSiO_{y}N having these compositions, and as a result, confirmed that all of the AgₓSiO_{y}N having a composition satisfying 0.030x<0.236 exhibited light transmittance of 60% or more. Furthermore, it has been confirmed that the electrical conductivity of AgₓSiO_{y}N linearly increased as the Ag molar ratio (x) increases under the condition satisfying 0.030≤x≤0.236. Based on this, the present inventors propose 0<x≤0.3 as the optimal Ag molar ratio (x) of the AgₓSiO_{y}N transparent anode active material.

In accordance with the experimental results to be described later, the electrical conductivity of SiO_{0.7}N undoped with Ag nanoparticles is 0.178 kS/cm, the electrical conductivity of Ag_{0.030}SiO_{0.7}N with an Ag molar ratio (x) of 0.030 is 21.0 kS/cm, and the electrical conductivity of Ag_{0.236}SiO_{0.7}N with an Ag molar ratio (x) of 0.030 is 67.5 kS/cm, indicating that the electrical conductivity of AgₓSiO_{y}N with an Ag molar ratio (x) of 0.236 is 100 times or more higher than that of SiO_{0.7}N.

Meanwhile, the Ag molar ratio (x) may exceed 0.3 and extend up to 0.8. As described above, as the Ag molar ratio (x) increases, the light transmittance characteristic decreases, while the electrical characteristic improves. Thus, the discharge capacity characteristics of AgₓSiO_{y}N are improved and the light transmittance is reduced until the Ag molar ratio (x) exceeds 0.3 and extends to 0.8.

Based on the characteristics of the AgₓSiO_{y}N anode active material according to the Ag molar ratio (x), the AgₓSiO_{y}N anode active material according to the present invention may be used for transparent or opaque purposes. That is, the AgₓSiO_{y}N anode active material having an Ag molar ratio (x) of 0<x≤0.3 has a light transmittance of 60% or more, and thus is applied as an anode active material for a transparent lithium ion battery or a transparent all-solid-state lithium thin-film battery. The AgₓSiO_{y}N anode active material having an Ag molar ratio (x) of 0.3<x≤0.8 has a light transmittance of less than 60%, but has better electrical characteristics, and thus can be applied as an anode active material for an opaque lithium ion battery or all-solid-state lithium thin-film battery.

The electrochemical characteristics of a lithium ion battery or an all-solid-state lithium thin-film battery are determined by charge/discharge capacity, rate performance, and lifespan characteristics. A large charge/discharge capacity enables long-term battery use, excellent rate performance enables high power output, and lifespan characteristics indicate the reliability of the battery. Here, the rate performance refers to a discharge capacity maintenance characteristic according to a charge/discharge rate, and the rate performance is evaluated to be superior as the discharge capacity is maintained high under a high charge/discharge rate.

Each of the lithium ion battery and the all-solid-state lithium thin-film battery to which the anode active material according to the present invention, i.e., the AgₓSiO_{y}N anode active material having the composition of Chemical Formula 1, is applied as an anode active material exhibits excellent charge/discharge capacity, rate performance, and lifespan characteristics.

It was confirmed that under the condition that satisfies 0.030≤x<0.765, as the Ag molar ratio (x) increases, both the charge/discharge capacity and rate performance of AgₓSiO_{y}N increase, and even after 100 charge/discharge cycles, the coulombic efficiency of each of the lithium ion battery and the all-solid-state lithium thin-film battery reaches 100%.

Referring to the experimental results to be described later, the discharge capacity of the all-solid-state lithium thin-film battery to which SiO_{0.7}N undoped with Ag nanoparticles is applied as an anode active material is 37.2 μAh/cm²·μm, whereas the discharge capacity of the all-solid-state lithium thin-film battery to which Ag_{0.236}SiO_{0.7}N is applied is 242.8 μAh/cm²·μm, indicating that the capacity increases by six times or more. Also, the discharge capacity of the lithium ion battery to which Ag_{0.564}SiO_{0.7}N is applied is 219.4 μAh/cm²·μm, which is comparable to that of the all-solid-state lithium thin-film battery.

In addition, compared to the all-solid-state lithium thin-film battery to which SiO_{y}N is applied, the all-solid-state lithium thin-film battery to which AgSiO_{y}N is applied exhibits excellent discharge capacity characteristics at a high charge/discharge rate (C). The all-solid-state lithium thin-film battery to which SiO_{y}N is applied operates only at a charge/discharge rate of up to 2C and does not operate at 5C or higher, whereas the all-solid-state lithium thin-film battery to which AgSiO_{y}N is applied showed a discharge capacity of 92.8 μAh/cm²·μm after 5 charge/discharge cycles at a charge/discharge rate of 10 C. The high discharge capacity characteristics under such a high charge/discharge rate, that is, the excellent rate performance mean that it can be applied to a high power device requiring a high power output. Here, 1 C means that the battery capacity is used within 1 hour, and 2 C means that the battery capacity is used within 30 minutes.

The anode active material having the composition of Chemical Formula 1 according to the present invention is not particularly limited in its manufacturing method, but it is preferable to use a process capable of depositing at room temperature. One of the reasons why room temperature deposition is desirable is to prevent a decrease in ionic conductivity of the solid electrolyte due to high-temperature deposition when manufacturing an all-solid-state lithium thin-film battery.

As an example, the anode active material thin film having a composition of Chemical Formula 1 may be manufactured by using a sputtering process. In the case of using the sputtering process, the anode active material having the composition of Chemical Formula 1 can be deposited on a substrate by mounting the substrate in a vacuum chamber and sputtering an Ag target and a Si target under an inert gas atmosphere containing nitrogen (N₂).

In the experimental example described later, AgSiO_{y}N thin films with various compositions were formed using off-axis continuous compositions-spread sputtering to set the optimal Ag molar ratio (x), and AgSiO_{y}N thin films with a uniform Ag molar ratio (x) may be formed through a typical sputtering process.

Meanwhile, in the case of using the sputtering process, as described above, the Ag target and the Si target are sputtered in a vacuum chamber under an inert gas atmosphere containing nitrogen (N₂) to form a thin film on the substrate, and due to the oxygen (O) component contained in a trace amount in the vacuum atmosphere, the formed thin film is formed of AgₓSiO_{y}N, not AgₓSiN_{z}.

In performing the sputtering process, as the inert gas containing nitrogen (N₂), a mixed gas of nitrogen (N₂) and argon (Ar) may be used, and in this case, the N₂/Ar ratio is preferably set in the range of 1 to 3%. If the N₂/Ar ratio is less than 1%, the nitrogen composition in the AgₓSiO_{y}N thin film may be too low, and if the N₂/Ar ratio is greater than 3%, the electrical conductivity of the AgSiO_{y}N thin film is very low.

As the method of depositing the anode active material with the composition of Chemical Formula 1, pulsed laser deposition (PLD), plasma chemical vapor deposition (PECVD), or the like may be used in addition to the above-described sputtering method.

The anode active material according to the present invention having the composition of Chemical Formula 1 may be applied to an all-solid-state lithium thin-film battery. The all-solid-state lithium thin-film battery according to the present invention has a structure in which an anode current collector, an anode active material, a solid electrolyte, and a positive electrode active material are sequentially stacked on a substrate.

The substrate may be a transparent substrate or an opaque substrate, and its material is not limited. In an embodiment, any one of a glass substrate, a flexible substrate made of a polymer material, and a semiconductor substrate may be used.

The anode current collector may also be made of various transparent or opaque materials, and as shown in the experimental example described later, a transparent conductive material made of an alloy of Ni and Cr may be applied as the anode current collector.

As the anode active material, the anode active material having a composition of Chemical Formula 1 according to the present invention is applied. As the solid electrolyte, LiPON having transparent characteristics may be applied, but is not limited thereto. As the positive electrode active material, a material containing lithium is applied.

The all-solid-state lithium thin-film battery according to the present invention to which the anode active material having the composition of Chemical Formula 1 is applied exhibits excellent charge/discharge capacity, rate performance, and long lifespan characteristics, which are supported by experimental examples described later.

In addition, the anode active material having the composition of Chemical Formula 1 according to the present invention may be applied to a lithium ion battery, and the anode active material according to the present invention may be applied to all lithium ion batteries employing the anode active material. As an example, the lithium ion battery according to the present invention may have a structure in which a liquid electrolyte and a separator are provided between the anode active material and the positive electrode active material, wherein the anode active material may be the anode active material having the composition of Chemical Formula 1.

Hereinabove, the anode active material and its manufacturing method according to the present invention, and the lithium ion battery and all-solid-state lithium thin-film battery using the same have been described. Hereinafter, the present invention will be described in more detail through experimental examples.

### Experimental Example 1: Deposition of AgₓSiO_{y}N Thin Film with Continuous Composition

An AgₓSiO_{y}N thin film was deposited on each of various substrates through an off-axis continuous compositions-spread sputtering process using a Si target and an Ag target under an N₂/Ar (N₂/Ar ratio of 2%) atmosphere at room temperature. The various substrates were a glass substrate (Glass), a glass substrate with Ni—Cr stacked (Ni—Cr/Glass), and a Cu foil (Cu foil), and reactive RF magnetron sputtering was applied. The distance between the substrate and the target (Ag and Si targets) was set to 75 mm, the operating pressure was 5 m Torr, and 98 sccm of N₂ and 2 sccm of Ar were injected. In this case, when the transparent anode active material (Ag molar ratio of 0.030≤x≤0.236) was prepared, 2.38 W and 0.27 W power were applied to the Si target and the Ag target, respectively, and when the high-capacity opaque anode active material (Ag molar ratio (x) of 0.261≤x≤0.765) was prepared, 2.38 W and 0.39 W were applied to the Si target and the Ag target, respectively. In order to optimize the Ag molar ratio (x), a power source under various conditions was applied to the Ag target.

For the AgₓSiO_{y}N thin film deposited on the Ni—Cr-stacked glass substrate (Ni—Cr/Glass), the thickness was measured using an SEM, and the electrical conductivity was measured using a Hall measuring device. In addition, for the AgₓSiO_{y}N thin film deposited on the glass substrate (Glass), the light transmittance in the wavelength range of 200 nm to 900 nm was measured using a UV-vis spectrophotometer. For comparison, an Ag-undoped SiO_{y}N thin film deposited on the glass substrate with Ni—Cr stacked (SiO_{y}N/Ni—Cr/Glass) was prepared, and its thickness, electrical conductivity, and light transmittance were analyzed.

### Experimental Example 2: Preparation of Coin Cells for Electrochemical Characteristics Analysis

In order to analyze the electrochemical characteristics analysis according to the composition of the AgₓSiO_{y}N thin film deposited on the Cu foil prepared according to Experimental Example 1 (AgₓSiO_{y}N/Cu foil), coin cells (type CR2032, Hohsen Corp.) were manufactured for each of 15 points of the AgₓSiO_{y}N thin film deposited on the Cu foil and having an Ag molar ratio (x) of 0.030≤x≤0.236 and each of 8 points of the AgₓSiO_{y}N thin film deposited on the Cu foil and having an Ag molar ratio (x) of 0.261≤x≤0.765. A LiPF₆/EC-DEC 1M solution was applied as the standard electrolyte, and Li foil was applied as the counter electrode. In the LiPF₆/EC-DEC, EC-DEC is ethylene carbonate diethylene carbonate.

The coin cells were measured in a glove box under an Ar atmosphere, and the electrochemical properties of the coin cells were analyzed by applying a voltage of 0.05 to 2 V at 0.2 C using an electrochemical measuring device. For comparison, a coin cell was also prepared using the Ag-undoped SiO_{y}N thin film deposited on the Cu foil, and its electrochemical properties were analyzed.

### Experimental Example 3: Manufacturing of All-Solid-State Lithium Thin-Film Battery

An all-solid-state lithium thin-film battery was manufactured by applying the AgₓSiO_{y}N thin film deposited on the glass substrate with Ni—Cr stacked (AgₓSiO_{y}N/Ni—Cr/Glass) prepared in Experimental Example 1 as a substrate, an anode current collector, and an anode active material, and applying LiPON as a solid electrolyte and Li as a counter electrode. The LiPON was deposited through RF sputtering, and 80 W power was applied to the Li₃PO₄ target under a 3 m Torr operating pressure and a 40 sccm N₂ atmosphere. The counter electrode Li was deposited at a ratio of 10 Å/s using a thermal depositor.

For the prepared all-solid-state lithium thin-film battery (Li/LiPON/AgₓSiO_{y}N/Ni—Cr/Glass), the electrochemical properties were analyzed by specifying four points (x=0.030(P1), 0.053(P5), 0.110(P10), and 0.236(P15)). For comparison, an all-solid-state lithium thin-film battery using the Ag-undoped SiO_{y}N thin film deposited on the glass substrate with Ni—Cr stacked (Li/LiPON/SiO_{y}N/Ni—Cr/Glass) was manufactured, and its electrochemical properties were also analyzed.

### Experimental Example 4: Analysis of Properties of AgₓSiO_{y}N Thin Film

The properties of the AgₓSiO_{y}N thin film prepared in Experimental Example 1 were analyzed.

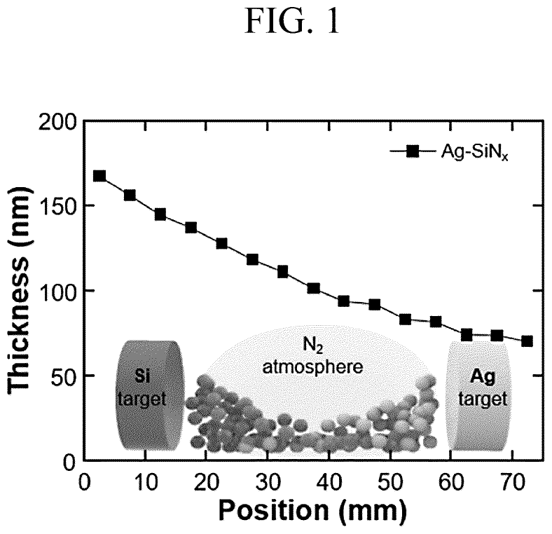

FIG. 1 shows a thickness change according to the position of the AgₓSiO_{y}N thin film prepared in Experimental Example 1, and from this, it can be seen that the thickness of the AgₓSiO_{y}N thin film becomes thicker as it is closer to the Si target, and the thickness of the AgₓSiO_{y}N thin film becomes smaller as it is closer to the Ag target.

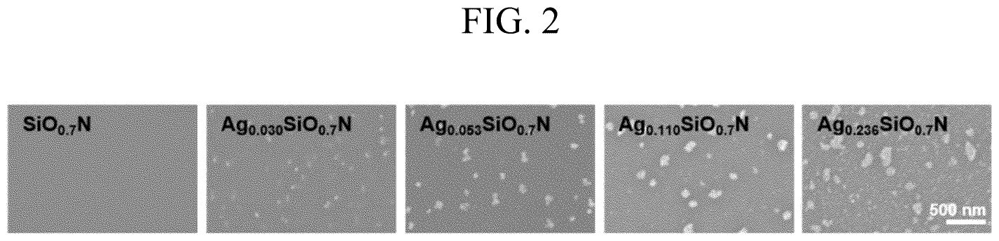

FIG. 2 is an SEM image of each of four points (x=0.030(P1), 0.053(P5), 0.110(P10), and 0.236(P15)) of the SiO_{y}N thin film produced in Experimental Example 1 and the AgₓSiO_{y}N thin film produced in Experimental Example 1. Referring to FIG. 2, it can be seen that the SiO_{y}N thin film exhibits a smooth and clean surface, and the Ag_{0.030}SiO_{0.7}N thin film has a form in which Ag nanoparticles having a diameter of 50 nm or less are evenly dispersed in the SiO_{0.7}N thin film. In addition, it can be seen that as the molar ratio (x) of Ag increases, the size of Ag nanoparticles tends to increase, and in the case of the Ag_{0.236}SiO_{0.7}N thin film, large Ag nanoparticles with a diameter of 80 to 270 nm and small Ag nanoparticles with a diameter of 20 to 30 nm are evenly distributed.

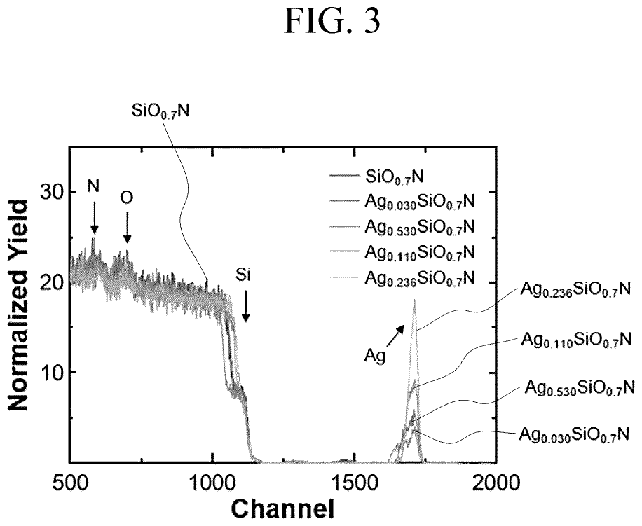

FIG. 3 shows the results of Rutherford backscattering spectroscopy analysis to confirm the composition of each of four points (x=0.030, 0.053, 0.110, and 0.236) of the SiO_{y}N thin film produced in Experimental Example 1 and the AgₓSiO_{y}N thin film produced in Experimental Example 1, and from this, an increase in Ag content can be confirmed by observing the rise of the Ag peak.

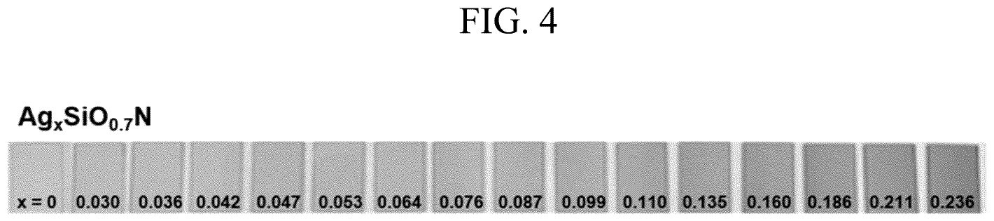

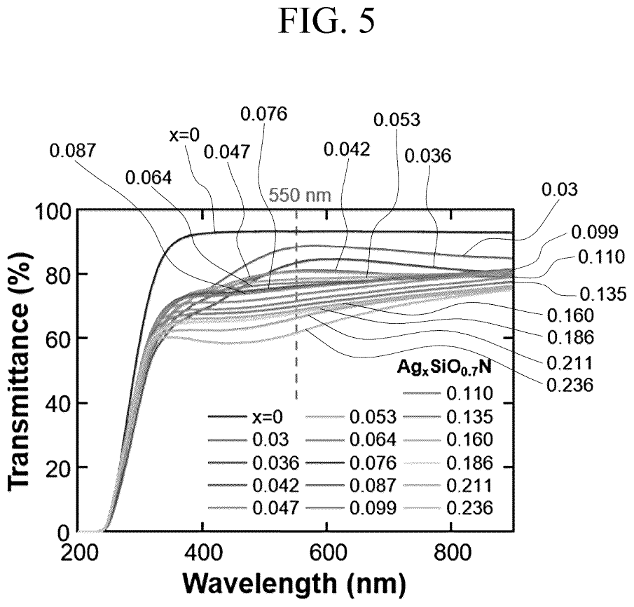

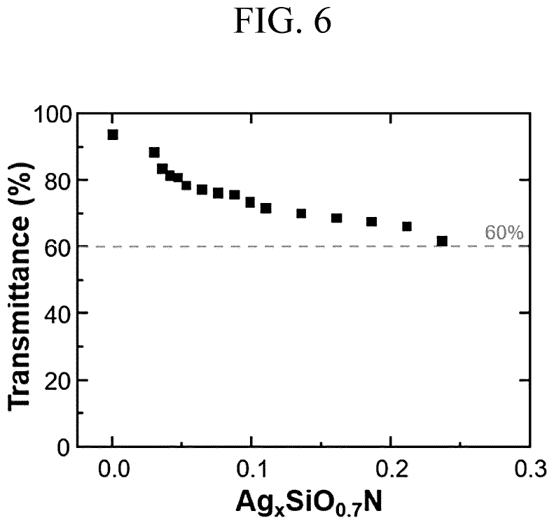

FIG. 4 is a photograph of each of 15 points (P1 to P15) of the SiO_{y}N thin film produced in Experimental Example 1 and the AgₓSiO_{y}N thin film produced in Experimental Example 1, and FIGS. 5 and 6 show the results of measuring a light transmittance at each point using a UV-vis spectrophotometer. Referring to FIG. 5, it can be seen that it tends to become darker as the Ag molar ratio (x) increases, and as illustrated in FIGS. 5 and 6, all 15 points (P1 to P15) of the AgₓSiO_{y}N thin film exhibit light transmittance of 60% or more at a wavelength of 550nm. Here, the human eye is most sensitive to light having a wavelength of 550 nm, and thus, a light transmittance standard for the display device is generally based on light having a wavelength of 550 nm.

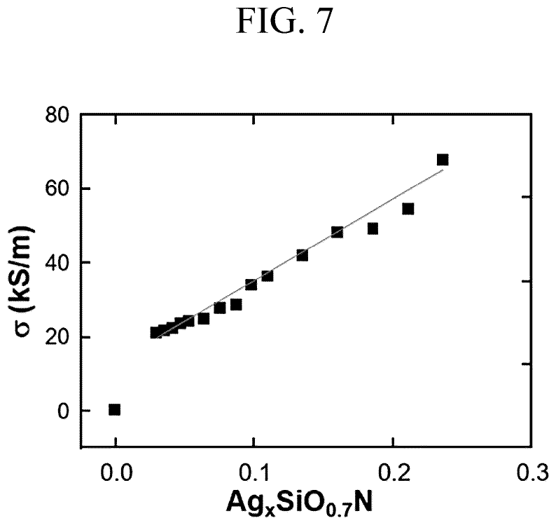

FIG. 7 is a result showing the electrical conductivity characteristics at each of 15 points (P1 to P15) of the SiO_{y}N thin film produced in Experimental Example 1 and the AgₓSiO_{y}N thin film produced in Experimental Example 1. Referring to FIG. 7, it can be confirmed that the electrical conductivity of the SiO_{0.7}N thin film is 0.178 KS/cm, the electrical conductivity of the SiO_{0.7}N thin film is 0.178 KS/cm, the electrical conductivity of the Ag_{0.030}SiO_{0.7}N thin film is 21.0 KS/cm, and the electrical conductivity of the Ag_{0.236}SiO_{0.7}N thin film is 67.5 KS/cm, indicating that the electrical conductivity of the Ag_{0.236}SiO_{0.7}N thin film is 100 times or more higher than that of the SiO_{0.7}N thin film.

### Experimental Example 5: Analysis of Electrochemical Properties Through Coin Cell Measurement

Charge/discharge characteristics and internal resistance characteristics are analyzed for 24 coin cells manufactured in Experimental Example 2. Among the 24 coil cells, 15 coin cells are those to which 15 points (P1 to P15) of the AgₓSiO_{y}N thin film having an Ag molar ratio (x) of 0.030≤x≤0.236 manufactured in Experimental Example 1 are respectively applied, 8 coin cells are those to which 8 points of the AgₓSiO_{y}N thin film having an Ag molar ratio (x) of 0.261≤x≤0.765 manufactured in Experimental Example 1 are respectively applied, and the remaining one coin cell is that to which the SiO_{y}N thin film is applied.

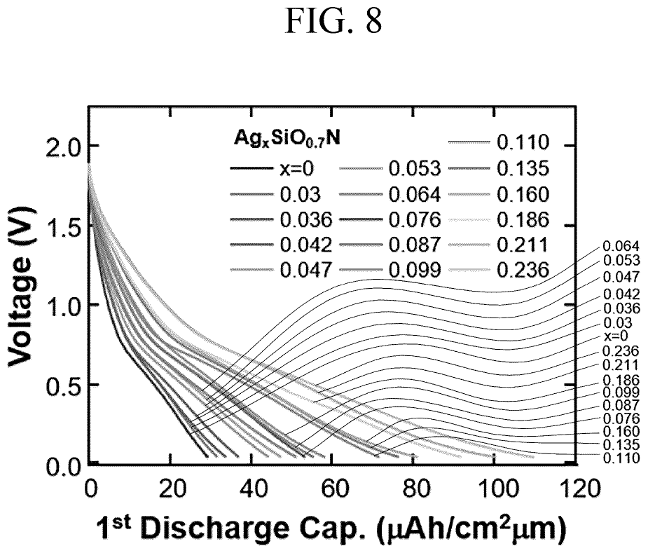

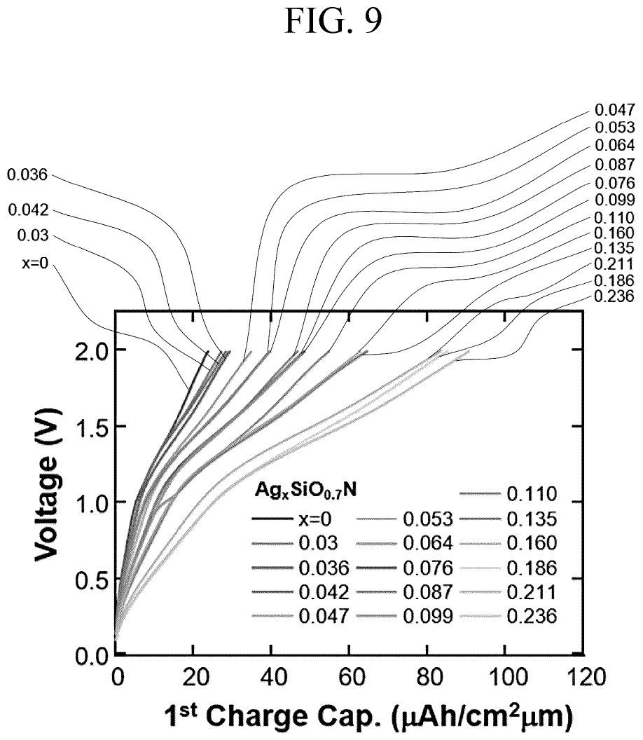

FIGS. 8 and 9 show the discharge characteristics during the first discharge and the charge characteristics during the first charge of 15 coin cells and the remaining 1 coin cell manufactured in Experimental Example 2 at a charge/discharge rate of 0.2 C, respectively. Referring to FIGS. 8 and 9, it can be seen that the coin cells to which the AgₓSiO_{y}N thin film is applied have better charge/discharge characteristics than the coin cells to which the SiO_{y}N thin film is applied in all compositions (0.030≤x≤0.236), and the discharge capacity increases as the Ag content increases. In particular, it can be seen that the discharge capacity of the coin cell to which the Ago_{0.236}SiO_{0.7}N thin film is applied is 112 μAh/cm²·μm, which is about 3.8 times better than that of the coin cell to which the SiO_{y}N thin film is applied, which has a discharge capacity of 29.2 μAh/cm²·μm.

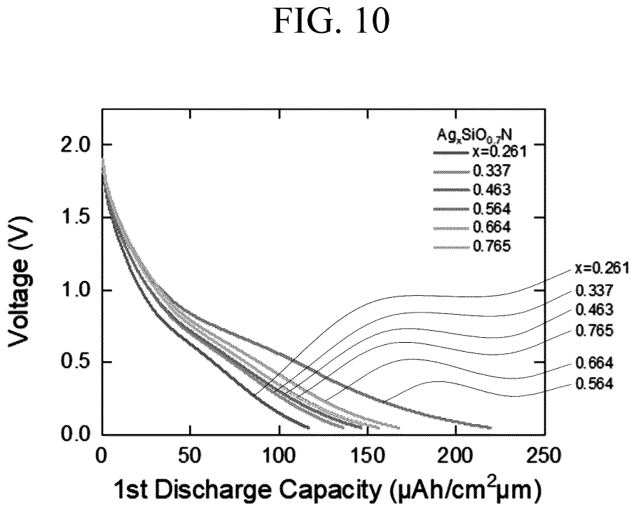

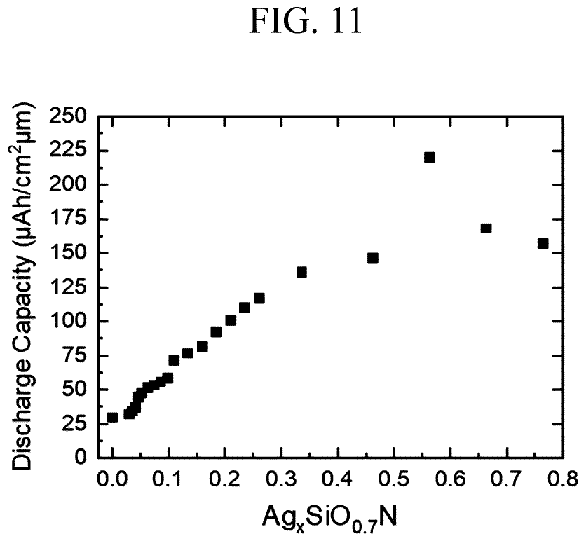

The characteristic of increasing discharge capacity according to the increase in Ag content is also shown in the eight coin cells to which the AgₓSiO_{y} N thin film having an Ag molar ratio (x) of 0.261≤x<0.765 is applied. FIG. 10 shows the discharge characteristics of the 8 coin cells manufactured in Experimental Example 2 during the first discharge at a charge/discharge rate of 0.2 C. Referring to FIG. 10, it can be seen that the discharge capacity of the coin cell to which the Ag_{0.765}SiO_{0.7}N thin film is applied is 219.4 μAh/cm²·μm, which is about 7.5 times better than that of the coin cell to which the SiO_{y}N thin film is applied, which has a discharge capacity of 29.2 μAh/cm²·μm. For reference, FIG. 11 is a collection of data from FIGS. 8 and 10, and shows discharge capacities of the 15 coin cells to which the AgₓSiO_{y}N thin film having an Ag molar ratio (x) of 0.030≤x≤0.236 is applied, the 8 coin cells to which the AgₓSiO_{y}N thin film having an Ag molar ratio (x) of 0.261≤x<0.765 is applied, and the 1 coin cell to which an SiO_{y}N thin film is applied, and through FIG. 11, the change in discharge capacity characteristics according to the Ag molar ratio (x) can be confirmed.

From these results, it is interpreted that in the case of the SiO_{y}N thin film that is not doped with Ag, the movement of electrons is hindered by a polarization phenomenon randomly distributed in the SiO_{y}N thin film, whereas in the case of the AgₓSiO_{y}N thin film that is uniformly doped with Ag, an electron conductive path is generated by the doped Ag, thereby increasing the discharge capacity and the charge capacity. However, among the eight coin cells to which the AgₓSiO_{y}N thin film having an Ag molar ratio (x) of 0.261≤x≤0.765 is applied, the discharge capacity of the coin cell having an Ag molar ratio (x) of 0.564 is the largest, and the discharge capacity tends to decrease at a higher Ag molar ratio (x) (x=0.664, 0.765), which indicates that the Ag content is excessively increased and the discharge capacity of Si is not sufficiently developed, resulting in a decrease in the discharge capacity.

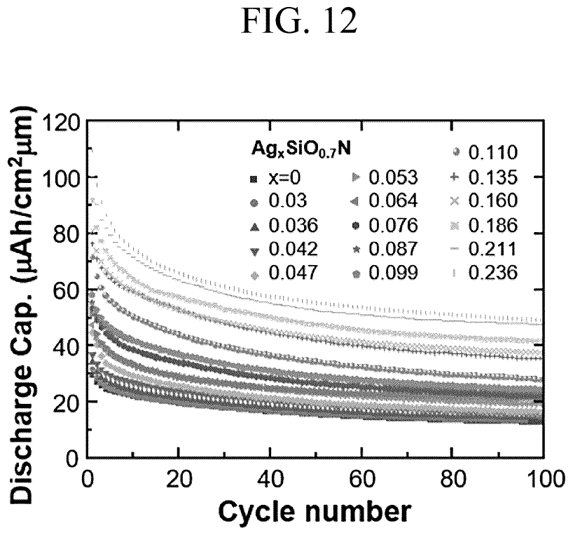

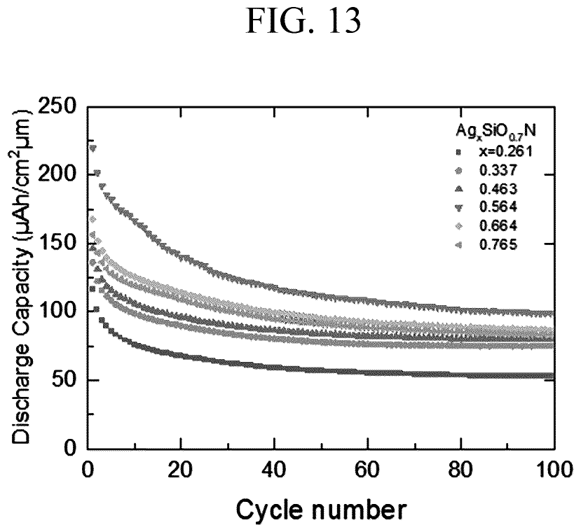

Meanwhile, referring to FIGS. 12 and 13, it can be seen that in the case of both the 15 coin cells to which the AgₓSiO_{y}N thin film having an Ag molar ratio (x) of 0.030≤x≤0.236 is applied, and the 8 coin cells to which the AgₓSiO_{y}N thin film having an Ag molar ratio (x) of 0.261≤x≤0.765 is applied, the discharge capacity remains stable even after 100 charging and discharging cycles, and the coulombic efficiency reaches 100%.

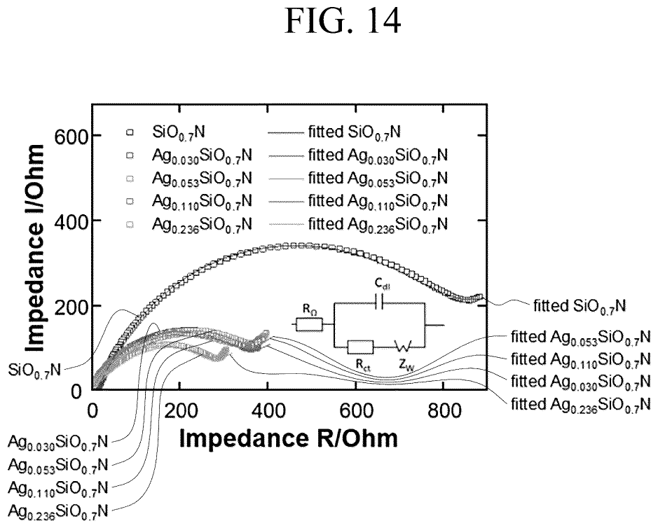

FIG. 14 shows the results of electrochemical impedance spectroscopy (EIS) performed on the 15 coin cells and the remaining one coin cell prepared in Experimental Example 2, and through this, the internal resistance of each coin cell can be confirmed. The Nyquist plots of FIG. 14 show a straight inclined line shape in a low frequency region and a semicircle shape in a high frequency region, and charge transfer resistance is related to the semicircle by R_{ct}. It can be seen that as the Ag content increases, the size of the semicircle of the Nyquist plot decreases, which means that as the Ag content increases, the charge transfer resistance decreases and the internal resistance of the coin cell decreases.

### Experimental Example 6: Analysis of Electrochemical Properties of All-Solid-State Lithium Thin-Film Battery

Electrochemical properties were analyzed for the all-solid-state lithium thin-film battery (x=0.030, 0.053, 0.110, and 0.236) manufactured in Experimental Example 3.

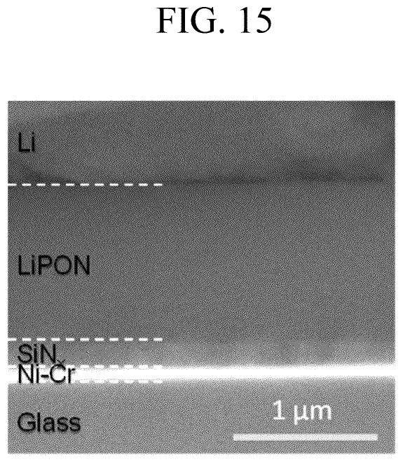

FIG. 15 is a FE-SEM image of the cross section of the all-solid-state lithium thin-film battery (Li/LiPON/AgₓSiO_{y}N/Ni—Cr/Glass) prepared in Experimental Example 3, and from this, it can be confirmed that cracks, pores, voids, etc. are not observed in each thin film. In addition, it can be seen that the interface between Li and LiPON and the interface between LiPON and AgₓSiO_{y}N are flat and smooth, which has a significant impact on the charge transfer and lifespan of the all-solid-state lithium thin-film battery. Li, LiPON, AgₓSiO_{y}N, and Ni—Cr of the all-solid-state lithium thin-film battery shown in FIG. 15 were calculated to be 1 μm, 1 μm, 160 nm, and 100 nm, respectively, and the light transmittance and ion conductivity of the all-solid-state lithium thin-film battery were measured to be 84% and 1.8×10⁻⁶ S/cm, respectively.

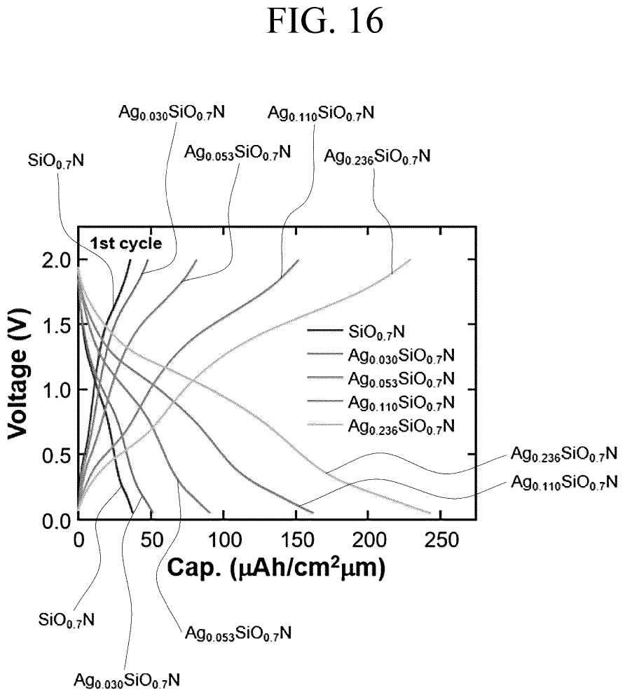

FIG. 16 shows charge/discharge characteristics of the all-solid-state lithium thin-film battery (x=0.030, 0.053, 0.110, and 0.236) manufactured in Experimental Example 3 under a charge/discharge rate of 0.2 C, and it can be seen that this shows a similar tendency to the charge/discharge characteristics of the coin cell (see FIGS. 8 and 9), but the charge/discharge capacity is increased compared to the coin cell. The increased charge/discharge capacity of the all-solid-state lithium thin-film battery compared to the coin cell is due to the volume expansion of silicon (Si) being suppressed by the solid electrolyte (LiPON) during charge/discharge.

As illustrated in FIG. 16, it can be seen that as the Ag content increases, the charge capacity and the discharge capacity increase, and the discharge capacity of the all-solid-state lithium thin-film battery to which Ag_{0.236}SiO_{0.7}N is applied is 242.8 μAh/cm²·μm, indicating that it is 6 times or more higher than 37.2 μAh/cm²·μm, which is the discharge capacity of the all-solid-state lithium thin-film battery to which SiO_{0.7}N is applied.

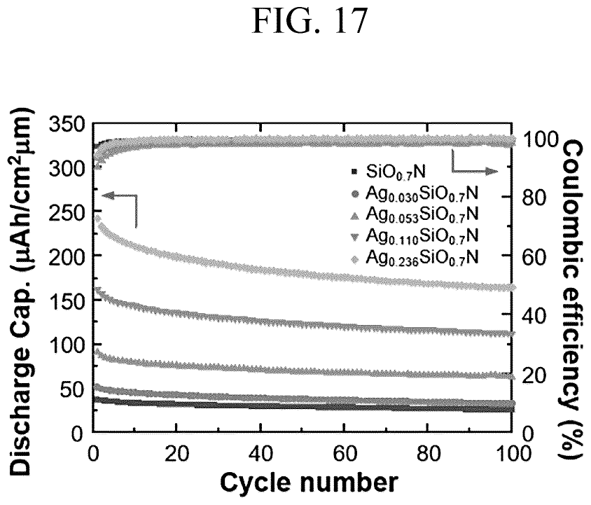

In addition, it can be seen that the coulombic efficiencies of the all-solid-state lithium thin-film battery (x=0, 0.030, 0.053, 0.110, and 0.236) prepared in Experimental Example 3 were 97.1%, 93.4%, 90.1%, 93.8%, and 94.4%, respectively, indicating that even if Ag is added, the decrease in Coulombic efficiency is limited. In addition, referring to FIG. 17, it can be seen that the coulombic efficiency of each all-solid-state lithium thin-film battery (x=0, 0.030, 0.053, 0.110, and 0.236) all reached 100% and was maintained up to 100 cycles.

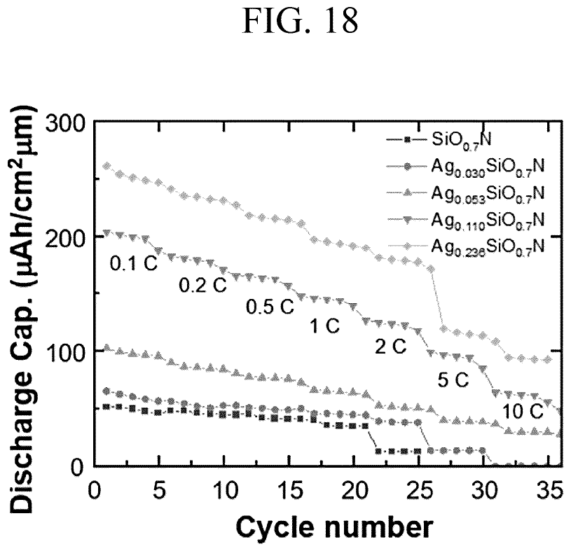

FIG. 18 shows the rate performance of the all-solid-state lithium thin-film battery (x=0, 0.030, 0.053, 0.110, and 0.236) manufactured in Experimental Example 3, which indicates that in the case of the all-solid-state lithium thin-film battery to which SiO_{0.7}N is applied, it operates only at a charge/discharge rate of up to 2 C, whereas in the case of the all-solid-state lithium thin-film battery to which Ag_{0.236}SiO_{0.7}N is applied, it exhibits a discharge capacity of 92.8 μAh/cm²·μm even at the 5^{th} cycle at a charge/discharge rate of 10 C. These results imply that the all-solid-state lithium thin-film battery to which AgₓSiO_{y}N is applied has the characteristic of exhibiting high discharge capacity even at faster charge/discharge rates, and is fully applicable to high-power electronic devices.

### STATEMENT REGARDING PRIOR DISCLOSURES BY THE INVENTOR OR A JOINT INVENTOR

The inventors of the present application have made the following related disclosure in Yaelim Hwang et al., “Highly conductive Ag—SiNx composite thin film anode engineering for transparent battery,” Composites Part B, Vol. 262, No. 110829, Jun. 3, 2023. The related disclosure was made less than one year before the effective filing date (Aug. 29, 2023) of the present application. The present application does not include four authors (Kwanyoung Oh, Jiseul Park, Sohee Kim, Ho-Won Jang) of the disclosure. However, these authors did not make contribution to conception of the invention (e.g., worked as an equipment operator and a technician), and thus are not included in the joint inventors of the present Application. Accordingly, the related disclosure is grace period inventor disclosure, and thus is disqualified from prior art under 35 U.S.C § 102(a)(1) against the present application. See 35 U.S.C § 102(b)(1)(A).

What is claimed is:

1. An anode active material characterized by comprising a material of Chemical Formula 1 below:
AgₓSiO_{y}N [Chemical Formula 1]
wherein x is 0<x≤0.8 and y is 0<y≤1.

2. The anode active material according to claim 1, characterized in that the Ag molar ratio (x) is 0.030≤x≤0.236.

3. The anode active material according to claim 2, characterized in that it has a light transmittance of 60% or more for light with a wavelength of 550 nm.

4. The anode active material according to claim 2, characterized in that it has a maximum electrical conductivity of 67.5 kS/cm.

5. The anode active material according to claim 1, characterized in that the Ag molar ratio (x) is 0.030≤x≤0.765.

6. An all-solid-state lithium thin-film battery having a structure in which an anode current collector, an anode active material, a solid electrolyte, and a positive electrode active material are sequentially stacked on a substrate,
wherein the anode active material is characterized by comprising a material of Chemical Formula 1 below:
AgₓSiO_{y}N [Chemical Formula 1]
wherein x is 0<x≤0.8 and y is 0<y≤1.

7. The all-solid-state lithium thin-film battery according to claim 6, characterized in that the Ag molar ratio (x) is 0.030≤x≤0.765.

8. The all-solid-state lithium thin-film battery according to claim 6, characterized in that the anode active material has an Ag molar ratio (x) of 0.030≤x≤0.236, and a light transmittance of 60% or more.

9. The all-solid-state lithium thin-film battery according to claim 8, characterized in that it has a maximum discharge capacity of 242.8 μAh/cm²·μm.

10. The all-solid-state lithium thin-film battery according to claim 8, characterized in that it has a discharge capacity of 92.8 μAh/cm²·μm or more at a charge/discharge rate of 10 C.

11. The all-solid-state lithium thin-film battery according to claim 6, characterized in that the anode current collector, the solid electrolyte and the positive electrode active material comprise transparent materials.

12. A lithium ion battery characterized by employing a material of the following Chemical Formula 1 as an anode active material:
AgₓSiO_{y}N [Chemical Formula 1]
wherein x is 0<x≤0.8 and y is 0<y≤1.

13. The lithium ion battery according to claim 12. characterized in that the Ag molar ratio (x) is 0.030≤x≤0.765.

14. The lithium ion battery according to claim 12. characterized in that it has a maximum discharge capacity of 219.4 μAh/cm²·μm.
